(19) United States
(12) Patent Application Publication
(10) Pub. No.: US 2002/0133464 A1
(43) Pub. Date: Sep. 19, 2002

(54) System and method for providing on-line ancillary content for printed materials

(76) Inventors: Erica Ress, New York, NY (US); Stephen Reisman, New York, NY (US)

Correspondence Address: David E. Franklin, Wood, Herron & Evans, L.L.P., 2700 Carew Tower, 441 Vine Street, Cincinnati, OH, 45202-2917, US

(21) Appl. No.: 09/809,780

(22) Filed: Mar. 16, 2001

(51) Int. Cl. H04K 1/00; H04L 9/00; G06F 17/60

(52) U.S. Cl. 705/51

(57) ABSTRACT

A system and method of providing ancillary on-line content for a literary work provides up-to-date and multi-media content, increasing the value to a user of a copy of the literary work, such as a printed textbook. In return, an author or publisher of the literary work has additional opportunities for revenues after the initial sale of copies of the literary work. The on-line ancillary content is restricted to users who have a password subject to an access limit such as an expiration date. The system characterizes the literary work and locates on-line updates based on the characterization. In addition, The ancillary distribution content system and method facilitates communication between users of the literary work, evaluators considering use of the literary work, publishers, and interactive classroom environments that utilize the literary work.

### TECHNICAL FIELD

The present invention generally relates to a system and a method for providing on-line content and, more particularly, to a system and a method for providing on-line ancillary content for literary works, including printed materials such as textbooks.

### BACKGROUND OF THE INVENTION

Educational publishers have developed various methods of selling educational materials to students. As will become apparent from the discussion below, these methods contain various inherent shortcomings. The first phase of a publisher's marketing effort is to persuade instructor(s) and/or educational institution(s) to adopt that publisher's textbook(s) and supplemental textbook material(s) for the classes offered by the instructor and the institution. A common practice is to send review copies and advertising materials to instructors, and to send sales information to the educational institutions, particularly the bookstores affiliated with the institutions.

The process of sending review copies for marketing purposes leads to less than satisfactory results. First, textbook decisions are often made well before the beginning of classes, to give the schools and bookstores sufficient time to obtain copies for retail sale. Thus, the publisher may not be able to formulate sales forecasts with satisfactory precision. Second, instructors sometimes sell the review copies of books they receive. Third, sending marketing material to bookstores has its shortcomings because, in most cases, the marketing material goes to bookstores that have minimal input into the textbook selection process. Selection decisions are generally made by instructors, professors, department chairmen, or administrators. Identifying the specific individual or individuals for a particular type of textbook is difficult.

Alternatively, blanketing all possible decision makers is expensive due to the large number of such individuals. Furthermore, large distribution is ineffective since each individual would receive marketing materials for certain types of literary works for which they are not the decision maker. Consequently, each individual is more likely to disregard all of the marketing material, including those portions that are appropriate.

Accordingly, a publisher would gain from an improved method of marketing its textbooks and other educational materials to instructors, who make decisions upon which large numbers of sales depend. A publisher would also gain from a reduction of the necessity of labor-intensive one-on-one marketing, relied upon by the publisher because each “customer” (i.e., instructor) is tied to so many retail sales. In fact, some lecture classes comprise hundreds of students purchasing tens of thousands of dollars worth of books and supplements.

The second part of a publisher's marketing effort is to accommodate the highly cyclical life cycle of the typical textbook used in an academic setting. Most academic institutions provide opportunities for students to sell back used textbooks to the school's bookstore for cash or credit. Where schools have not provided such an option, third-party vendors step in to fill the void. Most students sell their used textbooks, and thus there is a large pool of used books that students can purchase for that class in successive semesters. Used books are priced lower than new books and thus compete directly with the sale of new books. In many cases, students prefer used over new textbooks because the notes from previous owners of the book are helpful to them in understanding the material. Many schools offer popular classes two or more times per year, and thus the number of available copies of used textbooks grows quickly as a particular edition of a book gets older. As a result, sales of new copies of a particular edition drop off substantially the first semester after they are published, reducing the publisher's profitability margins.

Uncertainty in the publication of a new edition and selection as a course textbook leads to unpredictability and uncertainty in the textbook market. A particular edition of a textbook can also become outdated and obsolete, the degree of which depends upon the specific subject matter covered. For these reasons, a publisher typically issues new editions after approximately three years. This time period varies depending on a variety of factors. Nevertheless, the cyclical pattern of educational textbook publishing is a significant business impediment to educational publishers. Not only are educational textbooks revised more often than mass market publications and items offered for popular consumption, they are also usually printed in smaller press runs, driving up the per unit costs.

Demand for “required” textbooks is substantially inelastic in nature. As a result, a publisher is able to recoup some of the extra costs through premium pricing. However, this is an unsatisfactory solution because it also raises trade-in prices paid for used books, encourages greater use of used copies (driving down demand for new books) and also breeds consumer distrust and ill-will among those who purchase the books, as sell as the instructors who may feel obligated to specify the books. Moreover, premium pricing on the “required” books tends to reduce demand for supplemental materials that are not “required,” lowering overall sales. In addition, the smaller press runs of textbooks means that the unit cost curve is steeper than for other books. A publisher's uncertainty in the predicting overall demand translates into problems in matching demand with supply.

The short life cycle of textbooks incurs two primary disadvantages: frequent and expensive editorial revision and substantial variation in sales volume through the life of the book. Such variation in sales volume also lowers the overall revenue per customer for most of the life cycle; i.e., reduces the average number of sales.

### SUMMARY OF THE INVENTION

The invention addresses these and other problems associated with the prior art by providing a method of enhancing a literary work with on-line ancillary content that keeps the literary work up-to-date. Password protection for the ancillary content allows a publisher of the literary work to receive additional revenues from used copies of the literary work.

Consistent with one aspect of the invention, a method of distributing on-line ancillary begins with associating a password with a copy of a literary work. The password is set for a predetermined access limit. When a user inputs the password online, the password is verified to see if the predetermined access limit has expired. If unexpired, on-line ancillary content associated with the literary work is provided to the user.

The ancillary content may be based on material selected from existing, regularly updated news service content and typically includes, among other things, news stories based on events that occur after the publication of the textbook. Numerous advantages can be derived from this system and method, including the smoothing of sharp variations in textbook demand throughout the life of each edition. The “up-to-date” nature of the ancillary content permits the life span of each edition to be extended, thereby reducing editorial revision and printing costs. The use of existing and continually updated news stories may be leveraged to shift the burden for updating textbook content from the publisher to the electronic news publisher, as overseen by the author. The system and method create an opportunity for dynamic updating of the content of instructional materials by a text book author, based on current events and real-life contemporary examples of syllabus concepts, based on breaking news. The instructor may use this content to tailor a class-specific on-line supplement with items of geographical or topical interest. Student interest is increased by exposure to contemporary, interesting and socially relevant program materials, including multimedia and interactive content, if desired. Publishers can receive revenue from purchasers of used books by the bundled or on-line sale of individualized passwords to access updated electronic content and are provided with a cost-effective and potent marketing tool to induce interest in the textbooks by allowing demonstrations of how on-line news content can be introduced into course work.

These and many other advantages of the present invention will be more clearly understood and appreciated by careful study of the following, more detailed description of illustrative embodiments of the present invention, taken in conjunction with the accompanying drawings.

### BRIEF DESCRIPTION OF THE DRAWINGS

The accompanying drawings, which are incorporated in, and constitute a part of this specification, illustrate embodiments of the invention and, together with the general description of the invention given above and the detailed description of the embodiments given below, serve to explain the principles of the present invention.

FIG. 1 is a generalized block diagram showing a computer system for ancillary content distribution in which the present invention may be implemented.

FIG. 2 generally illustrates a computer usable in the system of FIG. 1.

FIG. 3 is a generalized block diagram showing flow of data in the computer system of FIG. 1.

FIG. 4 shows on-line content that is publicly accessible on the computer system of FIG. 1.

FIG. 5 shows on-line content with restricted access accessible on the computer system of FIG. 1.

FIG. 6 is a flowchart of a sequence of operations performed by an ancillary content provider of the computer system of FIGS. 1 and 3.

### DETAILED DESCRIPTION OF THE DRAWINGS

Ancillary on-line content for a literary work provides up-to-date and multi-media content, increasing the value to a user of a copy of the literary work, such as a book, a textbook, and printed matter. In return for enhancing the value to the user, an author or publisher of the literary work receives additional revenue after the initial sale of copies of the literary work. The additional revenue for the on-line ancillary content is obtained by selling or renewing passwords subject to an access limit such as an expiration date. As an additional benefit of providing ancillary content, the author or publisher receives feedback from users of the literary work that identify opportunities for further initial sales and desirable updates to the literary work.

Ancillary content, as used herein, includes on-line content that is associated with a literary work. One type of ancillary content is multi-media objects not available in a copy of the literary work. For example, in a printed matter copy of a literary work, such as a textbook, ancillary content may include an audio sound clip or a digital video clip. Another type of ancillary content are elaborations referenced, but not included in a copy of the literary work. For example, a bibliographic listing of links to primary and secondary source materials may be accessible as ancillary content. Another type of ancillary content is updates and corrections for content in a copy of the literary work. For example, textbooks with subjects affecting by current events may be updated by news stories that have occurred since the copy of the literary work was distributed. As another example, an e-book or textbook concerned with legal and regulatory issues may require updating to reflect changes in statute. As another example, a textbook on a nonfiction subject may include errors in the copy of the literary work that requires correction. As an additional example, based on user interest in certain aspects of the literary work, an author of the literary work may choose to provide an update that expands upon those aspects of the work. Consequently, ancillary content includes transmittable information that enhances a copy of a literary work.

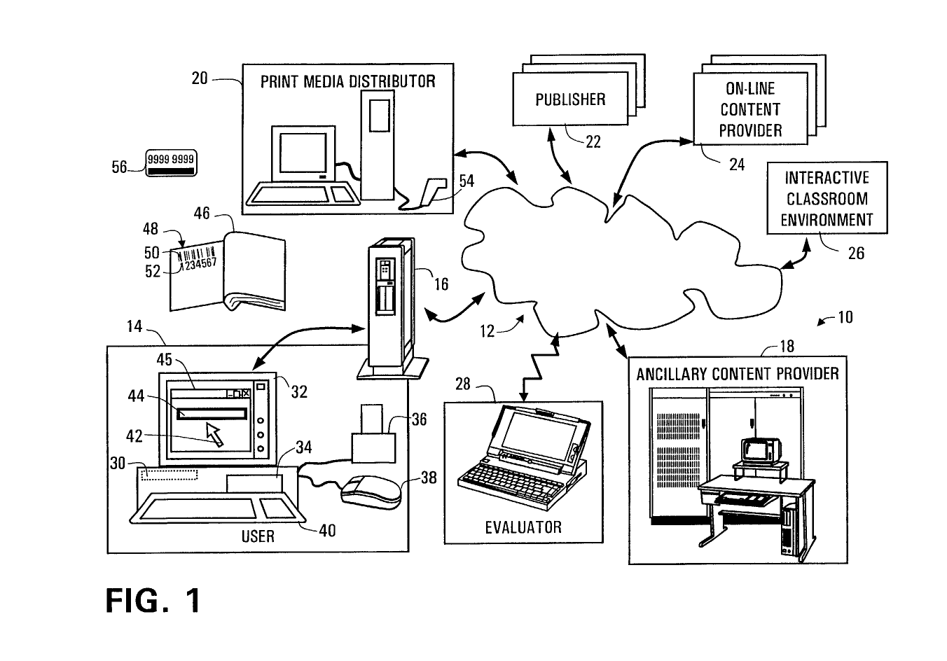

Turning to the Drawings, wherein like numbers denote like parts throughout the several views, FIG. 1 illustrates a computer system 10 consistent with the invention for on-line distribution of ancillary content for a literary work. Computer system 10 is illustrated as a networked computer system including one or more computers (e.g., desktop or PC-based computers, workstations, etc.) interacting with one another through a network 12. Network 12 may represent practically any type of networked interconnection, including but not limited to local-area, wide-area, wireless, and public networks (e.g., the Internet). Moreover, any number of computers and other devices may be networked through network 12, e.g., multiple servers.

In particular, a user computer 14 connects to the network 12 via a server 16 (e.g., a PC-based server, a minicomputer, a midrange computer, a mainframe computer, etc.) to obtain ancillary content from an ancillary content provider computer 18, which is also connected to the network 12. Other third-party computers are depicted as advantageously connected to the network 12: a print media distributor computer 20, a publisher computer 22, on-line content provider computer 24, an interactive classroom environment computer 26 and an evaluator computer 28.

User computer 14, which may be similar to computers 18-28, may include a central processing unit (CPU) 30; a number of peripheral components such as a computer display 32; a storage device 34; a printer 36; and various input devices (e.g., a mouse 38 and keyboard 40), among others. A user may move the mouse 38 to manipulate a cursor 42 and thereby interact with a hypertext object 44 in a window 45 present on the computer display 32. Server computer 16 may be similarly configured, albeit typically with greater processing performance and storage capacity, as is well known in the art.

A copy of a literary work, depicted as a textbook 46, is support by the ancillary content distributed over the computer system 10. Typically, the textbook 46 is purchased from a print media distributor associated with computer 20 by a user associated with computer 14. Although a copy of the literary work is depicted as printed matter, it will be apparent to one of ordinary skill in the art having the benefit of the instant disclosure that other forms may be used consistent with aspects of the invention. For example, an electronic book (“E-book”) may be purchased on magnetic media or downloaded to the user computer 14 or another type of viewer. As another example, the copy may comprise a compact disk containing text, sound clips and/or video clips.

In the illustrative embodiment, an identifier 48 for the copy and/or the literary work is illustrated as inscribed inside a cover of the textbook 46, specifically, a machine readable code depicted as a bar code 50 and a human readable code 52. The print media distributor computer 20 may advantageously include a bar code reader 54 for reading the bar code 50 for uses such as automatically activating a password associated with a particular copy.

An electronic card 56 is also depicted as an alternative or addition to the identifier 48. The print media distributor may sell the electronic card 56 with a prepaid value for redeeming a subscription period for ancillary content. The unique number inscribed on the electronic card, readable by human and/or machine, would serve as the identifier 48.

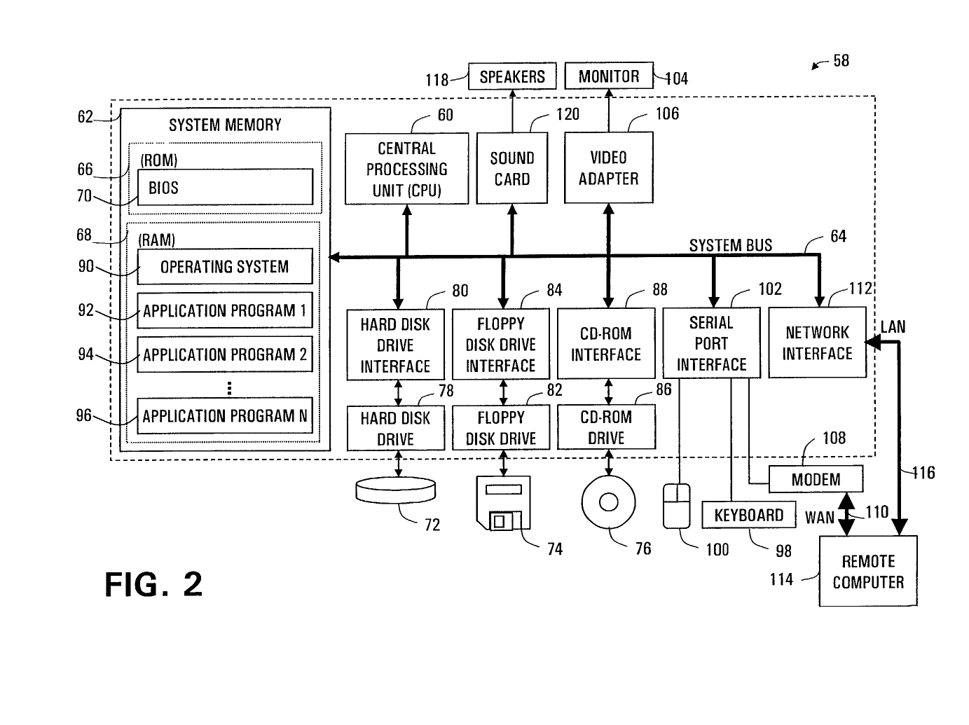

FIG. 2 illustrates in another way an exemplary hardware and software environment for an apparatus 58 consistent with the invention. For the purposes of the invention, apparatus 58 may represent practically any type of computer, computer system or other programmable electronic device, including a computer (e.g., similar to computers 14, and 18-28 of FIG. 1), a server computer (e.g., similar to server 16 of FIG. 1), a portable computer, a handheld computer, an embedded controller, etc. Apparatus 58 may be coupled in a network as shown in FIG. 1, or may be a stand-alone device in the alternative. Apparatus 58 will hereinafter also be referred to as a “computer”, although it should be appreciated the term “apparatus” may also include other suitable programmable electronic devices consistent with the invention.

Computer 58 typically includes at least one processor 60, depicted as a CPU, coupled to a system memory 62. A system bus 64 couples various system components, including system memory 62, to CPU 60. System bus 64 may be any of several types of bus structures, including a memory bus or memory controller, a peripheral bus, and a local bus using any of a variety of architectures. Processor 62 may represent one or more processors (e.g., microprocessors), and memory 62 may represent read-only memory (ROM) 66 and random access memory (RAM) 68 comprising the main storage of computer 58, as well as any supplemental levels of memory, e.g., cache memories, non-volatile or backup memories (e.g., programmable or flash memories), read-only memories, etc. A basic input/output system (BIOS) 70, containing the basic routines that help to transfer information between elements within computer 58, such as during start-up, is stored in ROM 66. In addition, memory 62 may be considered to include memory storage physically located elsewhere in computer 58, e.g., any cache memory in a processor 60, as well as any storage capacity used as a virtual memory, e.g., as stored on a mass storage device or on another remote computer. Computer 58 has mass storage devices including a (typically fixed) magnetic hard disk 72, a removable “floppy” or other magnetic disk 74, and a CD-ROM, or other optical media 76. The computer 58 may further include other types of mass storage such as direct access storage device (DASD), tape drive, etc. A hard disk drive 78 for hard disk 72 is connected to the system bus 64 via a hard disk drive interface 80. A floppy disk drive 82 for floppy disk 74 connects to the system bus 64 via a floppy disk drive interface 84. A CD-ROM drive 86 for CD-ROM 76 connects to the system base 64 via a CD-ROM interface 88.

A number of program modules are stored on mass storage media and/or ROM 66 and/or RAM 68 of system memory 62. Such program modules may include an operating system 90 providing graphics and sound application program interfaces (API), one or more application programs 92-96, other program modules, and program data. Computer 58 is preferably equipped with an operating system 90 supporting Internet communication protocols, such as Microsoft® Windows 98® or Microsoft® Windows NT® and a browser, such as Microsoft® Internet Explorer® or Netscape® Navigator®.

In general, the routines executed to implement the embodiments of the invention, whether implemented as part of an operating system or a specific application, component, program, object, module or sequence of instructions will be referred to herein as “computer programs”, or simply “programs”. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media such as volatile and non-volatile memory devices, floppy and other removable disks, hard disk drives, magnetic tape, optical disks (e.g., CD-ROM's, DVD's, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

A user may enter commands and information into the computer 58 through input devices such as a keyboard 98 and a pointing device 100. Other input devices may include a microphone joystick, game controller, satellite dish, scanner, or the like. These and other input devices are often connected to processing unit 60 through a serial port interface 102 that is coupled to system bus 64, but may be connected by other interfaces, such as a parallel port interface or a universal serial bus (USB). A monitor 104 or other type of display device is also connected to system bus 64 via an interface, such as a video adapter 106.

Computer 58 may also include a modem 108 or other means for establishing communications over wide area network (WAN) 110, such as communication network 12. Modem 108, which may be internal or external, is connected to system bus 64 via serial port interface 102. A network interface 112 may also be provided for allowing computer 58 to communicate with a remote computer 114 via local area network (LAN) 116 (or such communication may be via wide area network 110 or other communications pat such as dial-up or other communications means). Computer 58 typically includes other peripheral output devices, such as printers and other standard devices.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

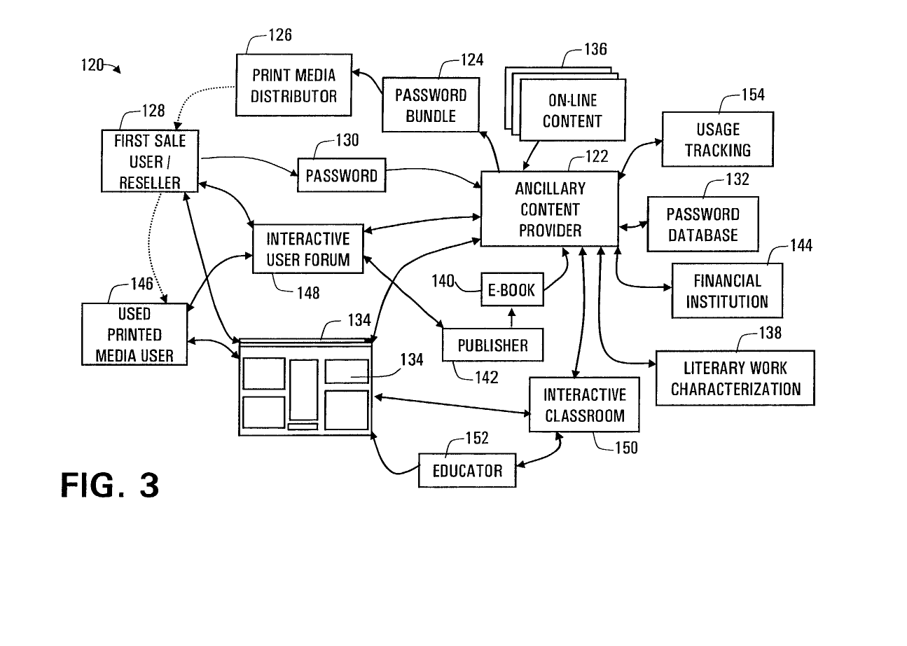

FIG. 3 illustrates an on-line ancillary content distribution environment 120 that may be performed on the computer system of FIG. 1. An ancillary content provider 122 provides bundled passwords 124 to a print media distributor 126. A first sale user 128 receives and uses a password 130 from the bundled passwords 124. The ancillary content provider 122 receives the password 130 from the first sale user 128 and responds by cross referencing the password 130 with password records contained within a password database 132. Thereby, the ancillary content provider 122 determines the associated literary work for the password 130 as well as any access limitations associated with the password 130. Then, the ancillary content provider 122 provides on-line ancillary content 134 derived from various sources of on-line content 136 based on a literary work characterization database 138.

In the illustrative embodiment, the ancillary content provider 122 uses eXtended Content Management (XCM)™ software from Vignette® Corporation of Austin, Tex. The literary work is keyword analyzed and the results stored in the literary work characterization database 138. As new on-line content 136 is made available, the new material is also characterized and correlated with the literary works, with the results also stored in the literary work characterization database 138.

For example, a printed material literary work may be organized into sections and chapters and have associated themes and topics for each of these portions (e.g., rules of evidence). The literary work characterization 138 advantageously goes a step further by creating tags for the literary work or portions of the literary work (e.g., meta-tags on hypertext content).

The on-line content 134 may advantageously include portions or the entirety of the literary work, such as an on-line searchable and viewable e-book 140 provided by a publisher 142 of the literary work. This expanded service may advantageously require a greater level of access for which the first sale user 128 provides payment, which may be purchased on-line with the ancillary content provider 122 credited via a financial institution 144. Having a full electronic version of the literary work may advantageously allow automatically analyzing portions for concepts and key words that are then stored in the literary work characterization 138 for dynamically associating with ancillary on-line content.

When a used printed media user 146 purchases a copy of the literary work from the first sale user 128, who now acts as a reseller, the used printed media user 146 has an opportunity to purchase or renew the password 130 in order to obtain on-line ancillary content 134.

The environment 120 facilitates additional interactive functions for these and other parties interested in the literary work. For example, additional feedback channels are established as an interactive user forum 148, e.g., e-mail, chat rooms, electronic bulletin boards, etc. Thereby, users 128, 146 gain additional insights into the literary work and the publisher 142 gains understandings of deficiencies in the literary work or opportunities for additional sales.

The on-line ancillary content 134 may advantageously be linked to interactive classrooms 150, such as education institution sponsored “WebCT” databases and web sites. The interactive classrooms 150 benefit from the additional information provided about the literary work. Educators 152 considering use of the literary work or actually using the literary work also benefit by having portions of the on-line ancillary content 134 that summarize usage, with such information maintained by the ancillary content provider 122 in a usage tracking database 154.

The interactive classroom 150 benefits by the “real-world” examples and updated material that makes the literary work more meaningful to the users, without requiring an educator the inconvenience of locating and distributing the material. Further enhancement can include integrating classroom management, testing, peer-to-peer interaction, student-to-instructor interaction, and student-to-author interaction.

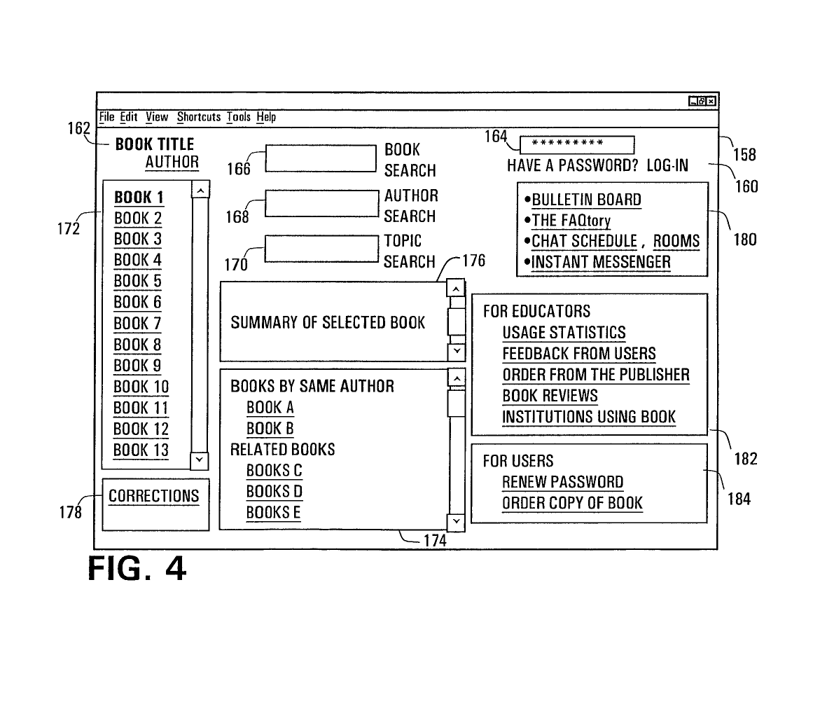

FIG. 4 illustrates a publicly accessible subset of the on-line ancillary content 134. In particular, a web browser window 158 renders a web page 160 containing unrestricted ancillary content associated with a literary work. A book title 162 identifies the literary work along with the author's name, which may have been selected by entering a password 164 having limited access. Alternatively, the book title 162 may have been selected by performing a search using a book search query 166, an author search query 168, or a topic search query 170. In response, a listing of search results is provided in a book listing subwindow 172 and books related by author and topic in a related listing subwindow 174. A user selecting one of the links in subwindows 172, 174 is provided unrestricted content such as a summary of the selected book, depicted as scrollable text window 176, and public updates 178, depicted as a corrections link.

Some interactive forum features 180 may be provided, even for passwords 164 without privileges for enhanced ancillary content, for example, a “bulletin board” link, “The FAQtory” link, a “Chat Schedule” link, Chat “Rooms” link, and an “Instant Messenger” link.

To encourage selection of the literary work, a “For Educators” subwindow 182 includes links for “Usage Statistics”, “Feedback from Users”, “Order from the Publisher”, “Books Reviews” and “Institutions Using Book”. Similarly, a “For Users” subwindow 184 provides links for “Renew Password” and “Order Copy of Book”.

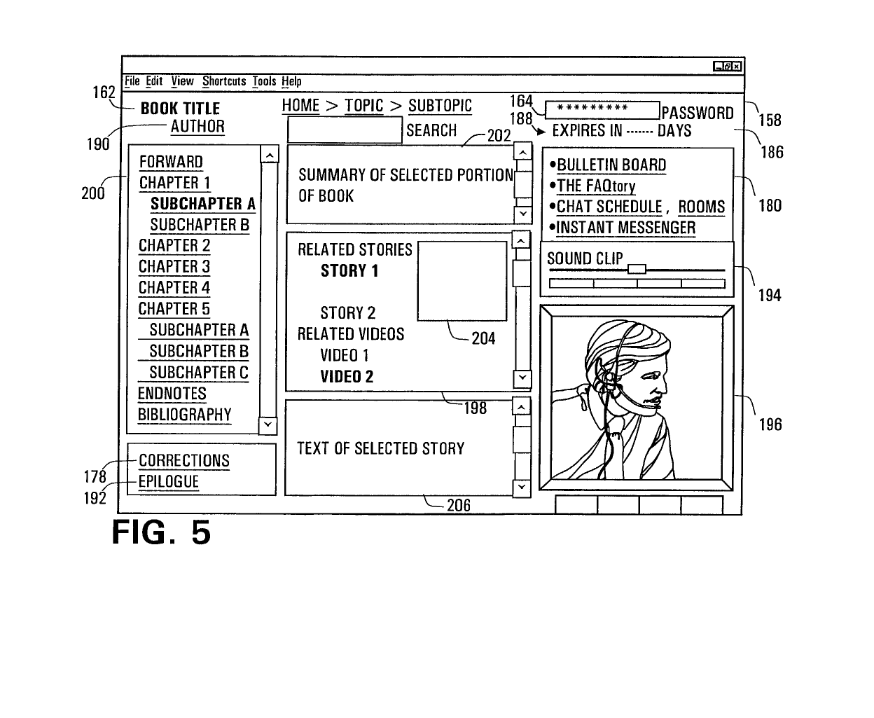

FIG. 5 illustrates a subset of the on-line ancillary content for a password 164 having broader access privileges. In particular, a web page 186 is rendered in window 158 that is useful for a user of the literary work. The status of the password 188 is displayed to alert the user as to the scope and/or duration of access to the privileged content.

In addition to the book title 162, an author link 190 may be provided, entitling a user to increased interaction with the author or access to on-line content controlled by the author. Moreover, in addition to public updates 178, the enhanced on-line ancillary content of web page 186 may include on-line updates from the author, depicted as an “Epilogue” link 192.

Ancillary content may advantageously include multi-media content, depicted as a sound clip player 194 and a video player 196. Multi-media content may be associated with the literary work at the time of publishing or later as an update based on related content located by the ancillary content provider 122. The multi-media content is listed in a related current news subwindow 198. In addition, text news and other types of ancillary content are listed in the related current news subwindow 198.

To assist the user, a portion of the literary work may be selected, such as by selecting a chapter link in a table of contents subwindow 200. Alternatively, radio buttons, pop-up menus, or pull-down menus may be employed. In response to selecting a specific portion of the literary work, a “Summary of the Selected Portion of the Book” subwindow 202 is displayed. Also, the related current news may be highlighted for the viewer by listing stories, videos, graphics 204, etc in subwindow 198. When a user selects content in subwindow 200, additional information is provided either in a “Text of Selected Story” subwindow 206, or by navigating to another web page.

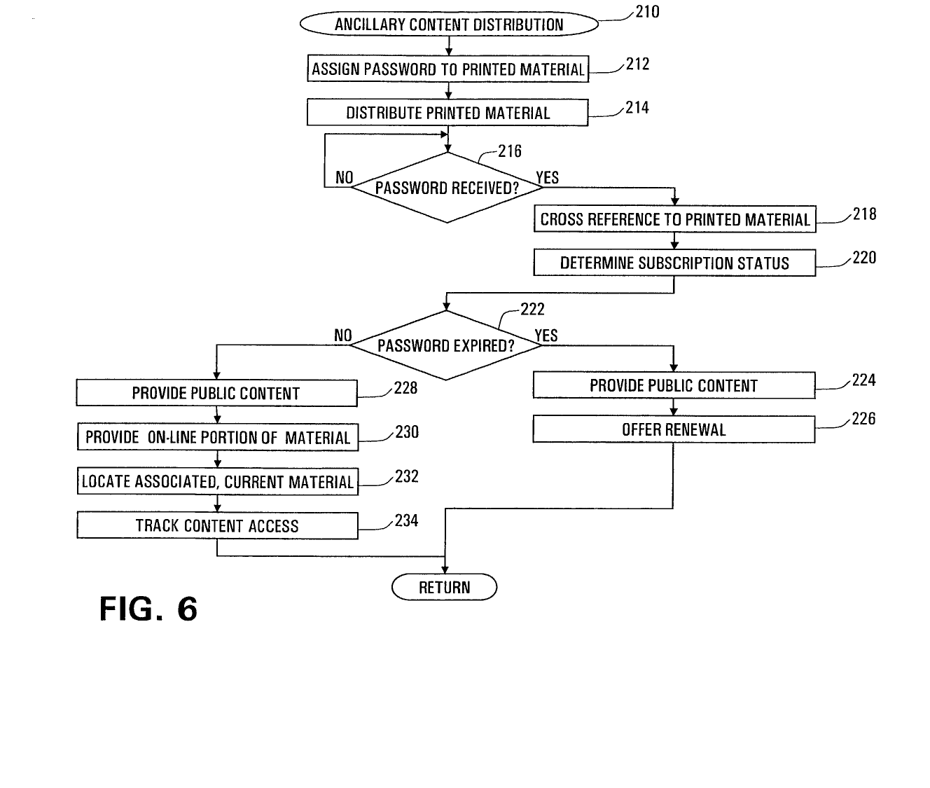

In use, FIG. 6 illustrates the operation of the ancillary content provider in distributing publicly accessible and restricted on-line ancillary content to a literary work in the form of printed material. In particular, a routine 210 begins in block 212 by assigning a password to a copy of the printed material and distributing the printed material (block 214). Then, control awaits use of the password by a user, such as depicted in block 216 wherein a determination is made as to whether the password has been received, and if not repeats block 216. If received, then the password is cross referenced to the printed material (block 218) and the subscription status of the password is determined (block 220).

If the password is determined to have expired in block 222, then publicly accessible content is provided (block 224) and an offer to renew the subscription for enhanced ancillary content is made (block 226). Otherwise, if in block 222 the password was determined to be unexpired, then public content is provided (block 228). Multi-media or enhanced on-line portions of the literary work designated at the time of publishing is provided (block 230). In addition, associated, current materials are associated with the literary work to offset obsolescence since the copy of the printed material was distributed and the located material provided to the user (block 232). Then, access and interaction by the user with the various types of on-line content are tracked to provide feedback for future updates to the literary work (block 234).

While the invention has been described in connection with what is presently considered to be the most practical and preferred embodiments, it is to be understood that the invention is not to be limited to the disclosed embodiments but, on the contrary, is intended to cover various modifications and equivalent arrangements included within the spirit and scope of the appended claims.

The invention in its broader aspects is, therefore, not limited to the specific details, representative apparatus and method, and illustrative examples shown and described. Accordingly, departures may be made from such details without departing from the spirit or scope of the general inventive concept.

Having described the invention, what is claimed is:

1. A method of distributing on-line ancillary content, comprising:
associating a password with a literary work;
setting a predetermined access limit to the password;
in response to receiving the password on-line, verifying that the predetermined access limit is unexpired; and
in response to the limit being unexpired, providing on-line ancillary content associated with the literary work.

2. The method of claim 1, wherein associating the password with the literary work comprises associating the password with a book.

3. The method of claim 2, wherein associating the password with the book further comprises:
defining a plurality of assigned passwords for the book; and
affixing a selected one of the assigned passwords to a copy of the book.

4. The method of claim 2, wherein the book comprises a plurality of copies of a textbook and at least one on-line portion reference in each copy. The method further comprising:
maintaining access to at least one on-line portion when the reference becomes obsolete; and
in response to receiving the obsolete reference, providing the on-line content.

5. The method of claim 1, wherein the ancillary content includes a subset of unrestricted content, the method further comprising:
in response to the limit being expired, providing unrestricted content associated with the literary work.

6. The method of claim 1, further comprising:
communicating on-line feedback regarding the literary work between at least two users selected from a group consisting of users of the literary work, educators evaluating the literary work, and originator of the literary work.

7. The method of claim 1, wherein setting the predetermined access limit comprises setting an expiration date.

8. The method of claim 7, wherein setting the expiration date of the predetermined access limit for the password further comprises:
receiving an indication of purchase of a password renewal; and
calculating the expiration date based on a predetermined interval from receipt of the indication of purchase.

9. The method of claim 8, wherein receiving the indication of purchase further comprises:
selling a password indicia to a print media distributor of the literary work.

10. The method of claim 9, wherein receiving the indication of purchase further comprises first on-line communication of the password after resale of the password indicia by the print media distributor.

11. The method of claim 8, wherein receiving the indication of purchase comprises:
electronically debiting an on-line purchase medium.

12. The method of claim 1, further comprising:
tracking on-line interaction with the on-line ancillary content associated with the literary work.

13. The method of claim 12, further comprising:
communicating statistical data regarding on-line interaction with a selected one of a group consisting of an interactive classroom moderator, an originator of the literary work, and a third-party on-line content provider of the ancillary content.

14. The method of claim 1, wherein setting the predetermined access limit to the password further comprises:
defining a plurality of access classes, each class assigned to a subset of the on-line ancillary content associated with the literary work; and
in response to a selection by a password holder of one of the access classes, limiting on-line access to the respective subset.

15. A method of providing ancillary on-line content for a literary work, comprising:
characterizing the literary work by key words;
storing the key words for associating with on-line content; and
associating the literary work with on-line content by correlating the stored key words with the on-line content.

16. The method of claim 15, wherein characterizing the literary work comprises identifying key words in a meta tag.

17. The method of claim 15, wherein correlating the stored key words with on-line content further comprises key word searching on-line news content.

18. An apparatus, comprising:
a memory;
a program, resident in memory, the program configured to associate a password with a literary work, to set a predetermined access limit to the password, to verify that the predetermined access limit is unexpired in response to receiving the password on-line, and to provide on-line ancillary content associated with the literary work in response to the limit being unexpired.

19. An apparatus, comprising:
a memory;
a program resident in memory, the program configured to access a characterization of a literary work to an on-line user request for on-line content for a literary work, to associate on-line content to the characterization, and to provide the on-line content to the user.
